(19) United States
(12) Patent Application Publication
(10) Pub. No.: US 2007/0276973 A1
(43) Pub. Date: Nov. 29, 2007

(54) Managing queues

(75) Inventors: Andrew Tan, Chandler, AZ (US); James Bury, Chandler, AZ (US)

Correspondence Address: FISH & RICHARDSON, PC, P.O. BOX 1022, MINNEAPOLIS, MN, 55440-1022, US

(73) Assignee: Intel Corporation

(21) Appl. No.: 10/955,911

(22) Filed: Sep. 30, 2004

(51) Int. Cl. G06F 13/00

(52) U.S. Cl. 710/112

(57) ABSTRACT

Monitoring the state of a queue includes (a) determining when values of a head pointer of the queue and a tail pointer of the queue are consistent with the queue being either empty or full, (b) storing a state responsive to changes in at least one of the head pointer and the tail pointer, and (c) when the values of the head pointer and the tail pointer are consistent with the queue being either empty or full, using the stored state to distinguish between the queue being empty and the queue being full.

### BACKGROUND

This invention relates to packet processing in switched fabric networks.

PCI (Peripheral Component Interconnect) Express is a serialized I/O interconnect standard developed to meet the increasing bandwidth needs of the next generation of computer systems. PCI Express was designed to be fully compatible with the widely used PCI local bus standard. PCI is beginning to hit the limits of its capabilities, and while extensions to the PCI standard have been developed to support higher bandwidths and faster clock speeds, these extensions may be insufficient to meet the rapidly increasing bandwidth demands of PCs in the near future. With its high-speed and scalable serial architecture, PCI Express may be an attractive option for use with or as a possible replacement for PCI in computer systems. The PCI Special Interest Group (PCI-SIG) manages PCI specifications (e.g., PCI Express Base Specification 1.0a) as open industry standards, and provides the specifications to its members.

Advanced Switching (AS) is a technology which is based on the PCI Express architecture, and which enables standardization of various backplane architectures. AS utilizes a packet-based transaction layer protocol that operates over the PCI Express physical and data link layers. The AS architecture provides a number of features common to multi-host, peer-to-peer communication devices such as blade servers, clusters, storage arrays, telecom routers, and switches. These features include support for flexible topologies, packet routing, congestion management (e.g., credit-based flow control), fabric redundancy, and fail-over mechanisms. The Advanced Switching Interconnect Special Interest Group (ASI-SIG) is a collaborative trade organization chartered with providing a switching fabric interconnect standard, specifications of which it provides to its members.

### BRIEF DESCRIPTION OF THE DRAWINGS

FIG. 1 is a block diagram of a switched fabric network.

FIG. 2 is a diagram of protocol stacks.

FIG. 3 is a diagram of an AS transaction layer packet (TLP) format.

FIG. 4 is a diagram of an AS route header format.

FIG. 5 is a block diagram of an end point.

FIG. 6 is a block diagram of a queue manager.

FIG. 7A-7B and 8A-8B are diagrams of queue pointer states.

FIG. 9 is a circuit diagram for a queue state module.

FIG. 10 is a state transition diagram for a finite state machine implemented in the circuit of FIG. 9.

### DETAILED DESCRIPTION

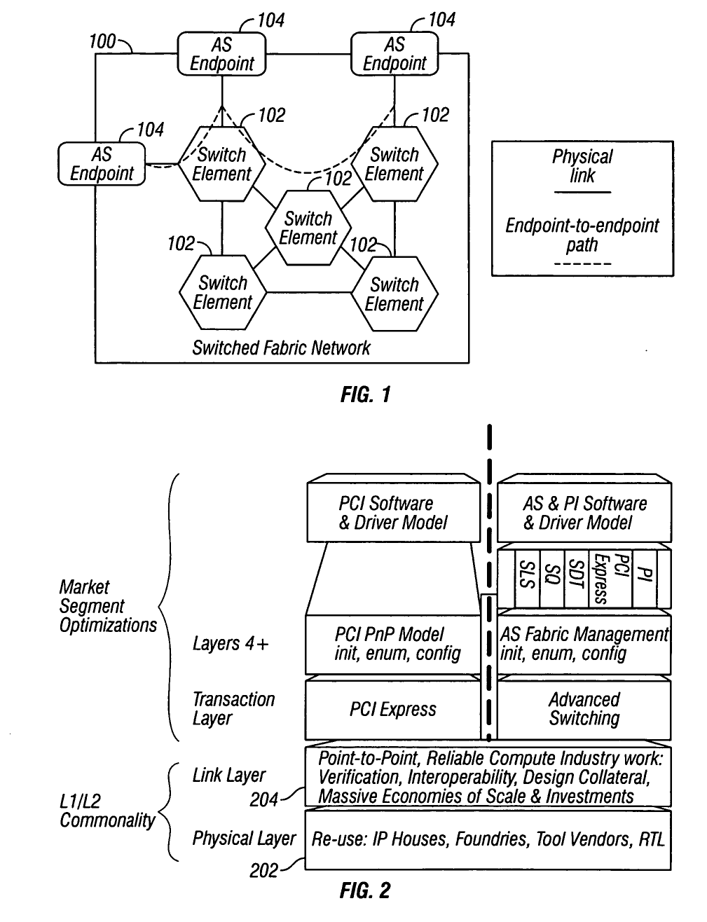

FIG. 1 shows a switched fabric network 100. The switched fabric network 100 includes switch elements 102 and end points 104. End points 104 can include any of a variety of types of hardware, e.g., CPU chipsets, network processors, digital signal processors, media access and/or host adaptors). The switch elements 102 constitute internal nodes of the switched fabric network 100 and provide interconnects with other switch elements 102 and end points 104. The end points 104 reside on the edge of the switched fabric network 100 and represent data ingress and egress points for the switched fabric network 100. The end points 104 are able to encapsulate and/or translate packets entering and exiting the switched fabric network 100 and may be viewed as “bridges” between the switched fabric network 100 and other interfaces (not shown) including other switched fabric networks.

Each switch element 102 and end point 104 has an Advanced Switching (AS) interface that is part of the AS architecture defined by the “Advance Switching Core Architecture Specification” (e.g., Revision 1.0, December 2003, available from the Advanced Switching Interconnect-SIG at www.asi-sig.org). The AS architecture utilizes a packet-based transaction layer protocol that operates over the PCI Express physical and data link layers 202, 204, as shown in FIG. 2.

The end points 104 typically include queues (e.g., input queues or output queues) for temporarily storing packets or portions of packets before being sent to and/or after arriving from the switch elements of the switched fabric network 100. In some implementations, an end point 104 includes a queue manager that maintains a circular buffer that provides storage space for a queue. The queue manager updates values of head and tail pointers that indicate the positions of the head and tail of the queue, respectively, within the circular buffer.

In some implementations, when the length of the queue, N, being managed (e.g., the number of addressable storage locations) is a power of two, the queue manager uses head and tail pointers that have 2^{N+1} bits. That is, they have an extra bit (e.g., a 4-bit pointer for a queue with 8 address locations). Each pointer is incremented as it passes forward through the ring buffer. The low order log₂N bits are used to identify the location pointed to by the pointer. The high order bit of each of the pointers is used to keep track of whether the queue is empty or full when the low order bits of the two pointers are equal. For example, when the low order bits of the head and tail pointers are equal, then the queue is empty if the high order bit of the head pointer is equal to the high order bit of the tail pointer, and the queue is full otherwise.

In other implementations, when the length of the queue being managed is not necessarily a power of two, then queue manager determines whether the queue is empty or full based on a stored state indicating whether the head pointer or the tail pointer was most recently updated. An exemplary queue manager that uses this approach is described in more detail below.

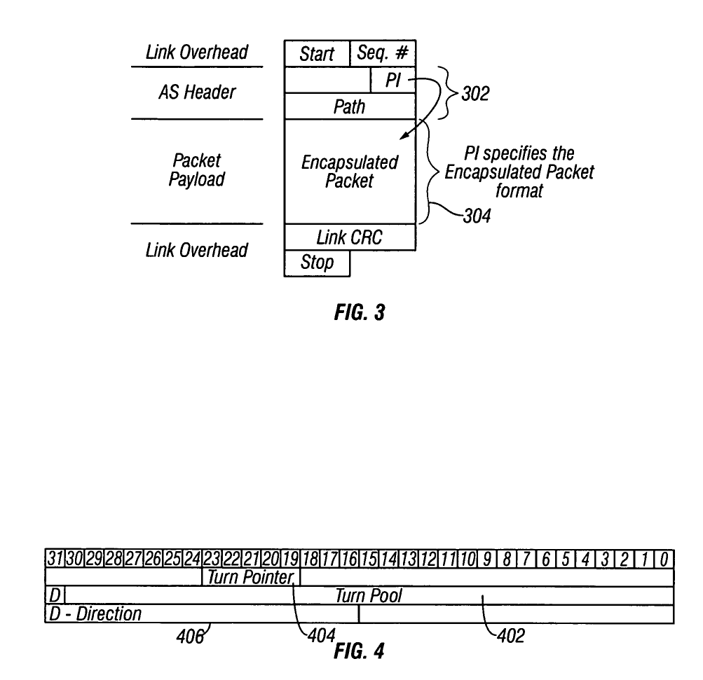

AS uses a path-defined routing methodology in which the source of a packet provides all information required by a switch (or switches) to route the packet to the desired destination. FIG. 3 shows an AS transaction layer packet (TLP) format 300. The TLP format 300 includes an AS header field 302 and a payload field 304. The AS header field 302 includes a Path field 302A (for “AS route header” data) that is used to route the packet through an AS fabric, and a Protocol Interface (PI) field 302B (for “PI header” data) that specifies the Protocol Interface of an encapsulated packet in the payload field 304. AS switches route packets using the information contained in the AS header 302 without necessarily requiring interpretation of the contents of the encapsulated packet in the payload field 304.

A path may be defined by the turn pool 402, turn pointer 404, and direction flag 406 in the AS header 302, as shown in FIG. 4. A packet's turn pointer indicates the position of the switch's “turn value” within the turn pool. When a packet is received, the switch may extract the packet's turn value using the turn pointer, the direction flag, and the switch's turn value bit width. The extracted turn value for the switch may then used to calculate the egress port.

The PI field 302B in the AS header 302 determines the format of the encapsulated packet in the payload field 304. The PI field 302B is inserted by the end point 104 that originates the AS packet and is used by the end point that terminates the packet to correctly interpret the packet contents. The separation of routing information from the remainder of the packet enables AS fabric to tunnel packets of any protocol.

The PI field 302B includes a PI number that represents one of a variety of possible fabric management and/or application-level interfaces to the switched fabric network 100. Table 1 provides a list of PI numbers currently supported by the AS Specification.

TABLE 1
AS protocol encapsulation interfaces

| PI number | Protocol Encapsulation Identity (PEI) |
|---|---|
| 0 | Fabric Discovery |
| 1 | Multicasting |
| 2 | Congestion Management |
| 3 | Segmentation and Reassembly |
| 4 | Node Configuration Management |
| 5 | Fabric Event Notification |
| 6 | Reserved |
| 7 | Reserved |
| 8 | PCI-Express |
| 9-95 | ASI-SIG defined PEIs |
| 96-126 | Vendor-defined PEIs |
| 127 | Reserved |

PI numbers 0-7 are used for various fabric management tasks, and PI numbers 8-126 are application-level interfaces. As shown in Table 1, PI number 8 (or equivalently “PI-8”) is used to tunnel or encapsulate a native PCI Express packet. Other PI numbers may be used to tunnel various other protocols, e.g., Ethernet, Fibre Channel, ATM (Asynchronous Transfer Mode), InfiniBand®, and SLS (Simple Load Store). An advantage of an AS switch fabric is that a mixture of protocols may be simultaneously tunneled through a single, universal switch fabric making it a powerful and desirable feature for next generation modular applications such as media gateways, broadband access routers, and blade servers.

The AS architecture supports the establishment of direct endpoint-to-endpoint logical paths through the switch fabric known as Virtual Channels (VCs). This enables a single switched fabric network to service multiple, independent logical interconnects simultaneously, each VC interconnecting AS end points for control, management and data. Each VC provides its own queue so that blocking in one VC does not cause blocking in another. Each VC may have independent packet ordering requirements, and therefore each VC can be scheduled without dependencies on the other VCs.

The AS architecture defines three VC types: Bypass Capable Unicast (BVC); Ordered-Only Unicast (OVC); and Multicast (MVC). BVCs have bypass capability, which may be necessary for deadlock free tunneling of some, typically load/store, protocols. OVCs are single queue unicast VCs, which are suitable for message oriented “push” traffic. MVCs are single queue VCs for multicast “push” traffic.

The AS architecture provides a number of congestion management techniques, one of which is a credit-based flow control technique that ensures that packets are not lost due to congestion. Link partners (e.g., an end point 104 and a switch element 102, or two switch elements 102) in the network exchange flow control credit information to guarantee that the receiving end of a link has the capacity to accept packets. Flow control credits are computed on a VC-basis by the receiving end of the link and communicated to the transmitting end of the link. Typically, packets are transmitted only when there are enough credits available for a particular VC to carry the packet. Upon sending a packet, the transmitting end of the link debits its available credit account by an amount of flow control credits that reflects the packet size. As the receiving end of the link processes the received packet (e.g., forwards the packet to an end point 104), space is made available on the corresponding VC. Flow control credits are then returned to the transmission end of the link. The transmission end of the link then adds the flow control credits to its credit account.

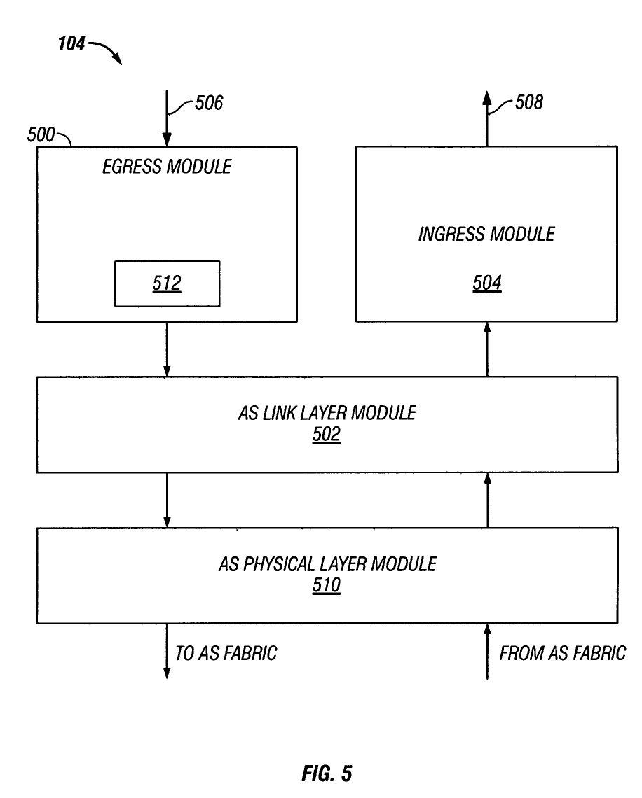

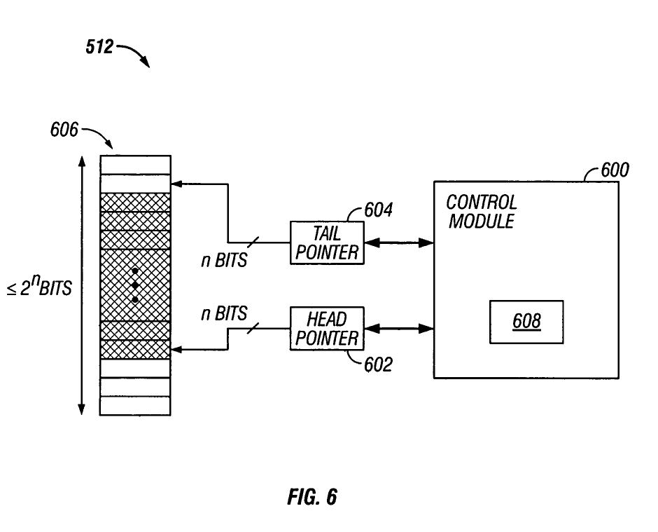

FIG. 5 shows a block diagram of functional modules in an implementation of an end point 104. The end point 104 includes an egress module 500 for transmitting data into the switched fabric network 100 via an AS link layer module 502. The end point also includes an ingress module 504 for receiving data from the switched fabric network 100 via the AS link layer module 502. The egress module 500 implements various AS transaction layer functions including building AS transaction layer packets, some of which include encapsulated packets received over an egress interface 506. The ingress module 504 also implements various AS transaction layer functions including extracting encapsulated packets that have traversed the switched fabric network 100 to send over an ingress interface 508. The AS link layer module 502 is in communication with an AS physical layer module 510 that handles transmission and reception of data to and from a neighboring switch element 102 (not shown).

An item in the queue may be stored in one or more address locations. An item is added to the queue (or “enqueued”) at the rear (or “tail”) of the queue. An item is removed from the queue (or “dequeued”) at the front (or “head”) of the queue. The tail pointer 604 locates the “tail” of the queue by pointing to the next available address in the circular buffer 606. The control module 600 increments the tail pointer 604 (by a possibly variable amount) after an item (e.g., a packet) is written to the queue. The head pointer 602 locates the “head” of the queue by pointing to the address in the circular buffer that stores the oldest data (e.g., a packet or a portion of a packet). The control module 600 increments the head pointer 602 by the appropriate amount after an item is read from the queue.

In this implementation, the values of the head pointer 602 and tail pointer 604 are equal both when the queue is empty and when the queue is full. When the values of the head and tail pointer are equal, a potential ambiguity in the empty/full state of the queue exists. (In other implementations the values of the head and tail pointers may indicate that the queue is either empty or full without being equal, for example, if they differ by 1.) The control module 600 includes a queue state module 608 for determining whether the queue is empty or full based on whether the head pointer or the tail pointer was most recently updated.

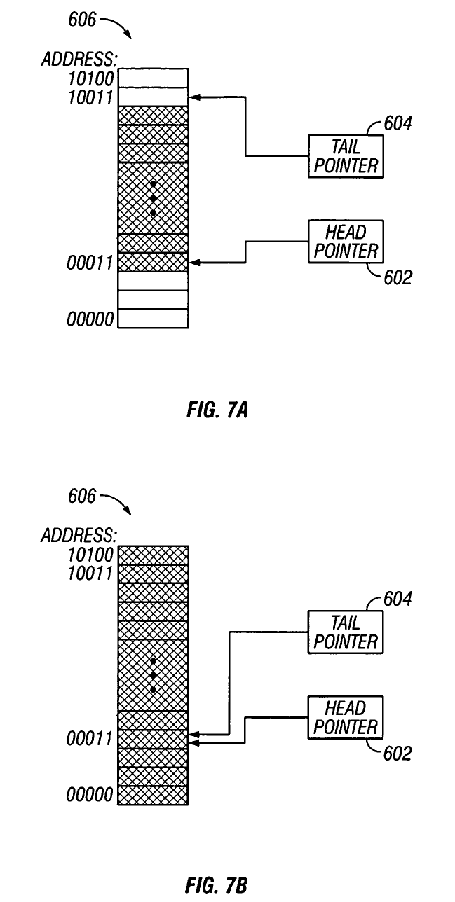

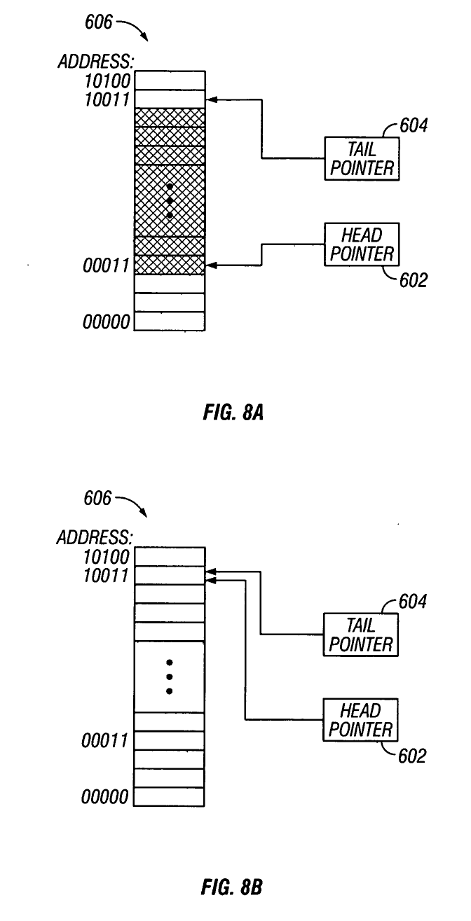

In one example, the circular buffer 606 uses N=21 address locations: address “00000” to address “10100.”If the queue goes from the state shown in FIG. 7A in which the head and tail pointer values are unequal (e.g., head_pointer=“00011” and tail_pointer=“10011”) to the state shown in FIG. 7B in which the head and tail pointer values are equal and the value of the tail pointer was updated last, then the queue is full. In this example, the tail pointer was incremented by enough to wrap around the “end” of the circular buffer 606 (from “10100” to “00000”). If the queue goes from the state shown in FIG. 8A in which the head and tail pointer values are unequal to the state shown in FIG. 8B in which the head and tail pointer values are equal and the value of the head pointer was updated last, then the queue is empty. If the queue is in a state in which the head and tail pointer values are equal and a last action included incrementing both the head and tail pointers, the state of the queue will remain full if the queue was previously full or remain empty if the queue was previously empty.

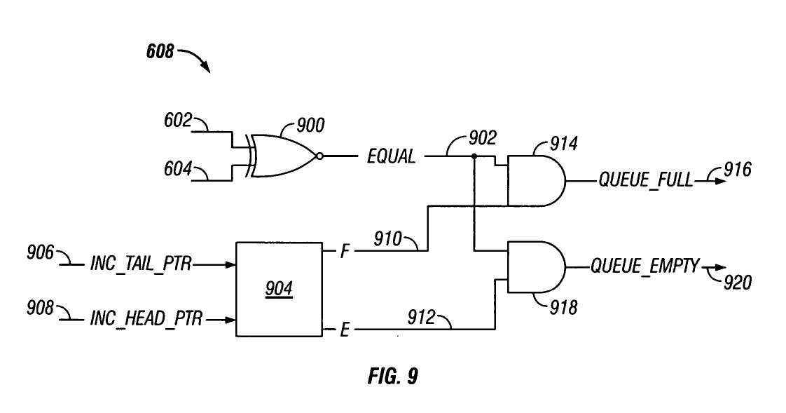

FIG. 9 shows a circuit diagram for an implementation of the queue state module 608. A comparator 900 compares the values of the head pointer 602 and the tail pointer 604. The comparator 900 provides an indicator 902 that indicates when the head and tail pointer are equal (which in this implementation indicates that the queue is either empty or full).

The circuit includes an implementation of a finite state machine (FSM) 904 (e.g., in hardware, software or both) that is used to distinguish between the full and empty states of the queue. State transitions occur at predetermined time intervals (e.g., every clock cycle). Inputs of the finite state machine 904 include an inc_tail_ptr signal 906 and an inc_head_ptr signal 908 that indicate (e.g., using binary logic with 1=“true” and 0=“false”) whether the tail and head pointers were incremented in the most recent time interval, respectively. An output signal 910 indicates when the FSM 904 is in an “F” state (denoted as “filling” state), and an output signal 912 indicates when the FSM 904 is in an “E” state (denoted as “emptying” state). An AND gate 914 generates a queue_full signal 916 (indicating the queue is full) from the indicator 902 and the signal 910. An AND gate 918 generates a queue_empty signal 920 (indicating the queue is empty) from the indicator 902 and the signal 912.

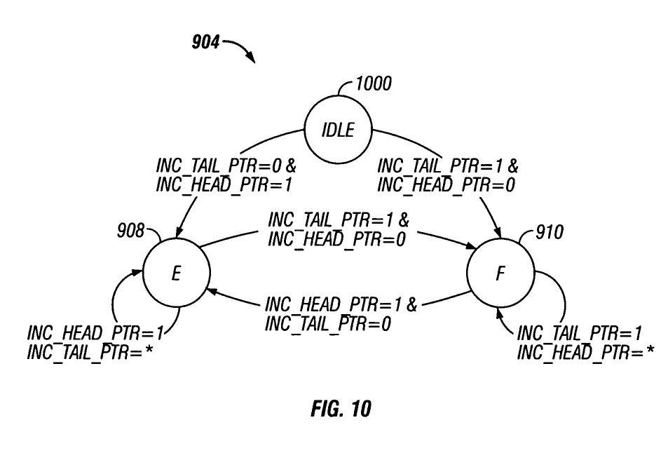

FIG. 10 shows a state transition diagram for the FSM 904. The FSM 904 starts in an “IDLE” state 1000. If inc_head_ptr=1 and inc_tail_ptr=0, the FSM 904 transitions to the “E” state. If inc_head_ptr=0 and inc_tail_ptr=1, the FSM 904 transitions to the “F” state. From the “E” state, if inc_head_ptr=1, the FSM 904 stays in the “E” state (inc_tail_ptr=* indicates that the value of inc_tail_ptr does not matter for that transition). If inc_head_ptr=0 and inc_tail_ptr=1, the FSM transitions from the “E” state to the “F” state. From the “F” state, if inc_tail_ptr=1, the FSM 904 stays in the “F” state (inc_head_ptr=* indicates that the value of inc_head_ptr does not matter for that transition). If inc_head_ptr=1 and inc_tail_ptr=0, the FSM transitions from the “F” state to the “E” state. Since no state transitions occur if neither pointer is incremented, transitions are not shown for head_ptr=0 and inc_tail_ptr=0. Other finite state machines can be used, including, for example, a finite state machine with two states.

The techniques described in this specification can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Processes described herein can be performed by one or more programmable processors executing a computer program to perform functions described herein by operating on input data and generating output. Processes can also be performed by, and techniques can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

The techniques can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of these techniques, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments. Other embodiments are within the scope of the following claims. For example, the steps of the invention can be performed in a different order and still achieve desirable results.

What is claimed is:

1. A method for monitoring the state of a queue comprising:
determining when values of a head pointer of the queue and a tail pointer of the queue are consistent with the queue being either empty or full;
storing a state responsive to changes in at least one of the head pointer and the tail pointer; and
when the values of the head pointer and the tail pointer are consistent with the queue being either empty or full, using the stored state to distinguish between the queue being empty and the queue being full.

2. The method of claim 1, wherein the stored state indicates whether the head pointer or the tail pointer was most recently updated.

3. The method of claim 2, wherein the stored state corresponds to one of two states of a finite state machine.

4. The method of claim 3, wherein the finite state machine includes a first transition from a first state to a second state that corresponds to incrementing the tail pointer but not the head pointer and a second transition from the second state to the first state that corresponds to incrementing the head pointer but not the tail pointer.

5. The method of claim 1, wherein the stored state is not changed if the head pointer and tail pointer were most recently updated together.

6. The method of claim 1, wherein the determining comprises determining when the value of the head pointer is equal to the value of the tail pointer.

7. The method of claim 1, wherein the queue comprises a circular buffer that defines a range of values for the head pointer and the tail pointer.

8. The method of claim 7, wherein the number of values in the range is not a power of two.

9. The method of claim 7, wherein the value of the head pointer or tail pointer wraps around at a value that is not one less than a power of two.

10. The method of claim 7, wherein the value of the head pointer or tail pointer wraps around at a value whose binary representation does not consist of all ones or all zeros.

11. The method of claim 1, wherein the queue stores packets.

12. The method of claim 11, wherein the packets comprise Advanced Switching transaction layer packets.

13. The method of claim 11, wherein the values of the head pointer and tail pointer are incremented by amounts based on respective sizes of variable length packets stored in the queue.

14. An apparatus for monitoring the state of a queue comprising:
circuitry configured to generate a signal that indicates when values of a head pointer of the queue and a tail pointer of the queue are consistent with the queue being either empty or full;
circuitry implementing a finite state machine for storing a state responsive to changes in at least one of the head pointer and the tail pointer; and
circuitry that uses the stored state to distinguish between the queue being empty and the queue being full when the signal indicates that the values of the head pointer and the tail pointer are consistent with the queue being either empty or full.

15. The apparatus of claim 14, wherein the stored state indicates whether the head pointer or the tail pointer was most recently updated.

16. The apparatus of claim 15, wherein the stored state corresponds to one of two states of the finite state machine.

17. The apparatus of claim 16, wherein the finite state machine includes a first transition from a first state to a second state that corresponds to incrementing the tail pointer but not the head pointer and a second transition from the second state to the first state that corresponds to incrementing the head pointer but not the tail pointer.

18. The apparatus of claim 14, wherein the signal indicates when the value of the head pointer is equal to the value of the tail pointer.

19. The apparatus of claim 14, wherein the queue comprises a circular buffer that defines a range of values for the head pointer and the tail pointer.

20. The apparatus of claim 19, wherein the number of values in the range is not a power of two.

21. The apparatus of claim 14, wherein the queue stores packets.

22. The apparatus of claim 21, wherein the packets comprise Advanced Switching transaction layer packets.

23. A system comprising:
a switched fabric network; and
a device coupled to the network including:
a circular buffer storing elements in the queue;
circuitry configured to generate a signal that indicates when values of a head pointer of the queue and a tail pointer of the queue are consistent with the queue being either empty or full;
circuitry implementing a finite state machine for storing a state responsive to changes in at least one of the head pointer and the tail pointer; and
circuitry that uses the stored state to distinguish between the queue being empty or full when the signal indicates that the values of the head pointer and the tail pointer are consistent with the queue being either empty and the queue being full.

24. The system of claim 23, wherein the stored state indicates whether the head pointer or the tail pointer was most recently updated.

25. The system of claim 23, wherein the queue stores packets.

26. The system of claim 25, wherein the packets comprise Advanced Switching transaction layer packets.
